(19) United States
(12) Patent Application Publication
(10) Pub. No.: US 2019/0241043 A1
(43) Pub. Date: Aug. 8, 2019

(54) VEHICLE AIR CONDITIONER

(71) Applicants: TOYOTA JIDOSHA KABUSHIKI KAISHA, Toyota-shi (JP); DENSO CORPORATION, Kariya-city (JP)

(72) Inventors: Koichi ITO, Handa-shi (JP); Takahisa FUJII, Kariya-shi (JP)

(73) Assignees: TOYOTA JIDOSHA KABUSHIKI KAISHA, Toyota-shi (JP); DENSO CORPORATION, Kariya-city (JP)

(21) Appl. No.: 16/239,588

(22) Filed: Jan. 4, 2019

(30) Foreign Application Priority Data
Feb. 2, 2018 (JP) 2018-017344

(51) Int. Cl. B60H 1/00; B60N 2/56; B60N 2/00

(52) U.S. Cl. CPC B60H 1/00821; B60H 1/00285; B60N 2/5628; B60H 2001/00185; B60N 2/002; B60N 2/5657; B60H 1/00021; B60H 1/00564

(57) ABSTRACT

A vehicle air conditioner includes: an air conditioner unit that generates conditioned air; a first duct that carries the conditioned air toward a vehicle upper side portion of the rear seat; a second duct that carries the conditioned air toward inside of a front seat of the vehicle; a switch device that switches between a first state that permits the conditioned air to flow into the second duct and restricts from flowing into the first duct, and a second state that permits the conditioned air to flow into the first duct and restricts from flowing into the second duct; occupant detection device that detecting whether a rear seat occupant is seated; and a controller, based on a detection result, controls the switch device to the first state when no rear seat occupant is seated, and to the second state when an occupant is seated at the rear seat.

### CROSS-REFERENCE TO RELATED APPLICATION

This application claims priority under 35 USC 119 from Japanese Patent Application No. 2018-017344, filed on Feb. 2, 2018, the disclosure of which is incorporated by reference herein.

### BACKGROUND

### Technical Field

The present disclosure relates to a vehicle air conditioner that generates conditioned air and conveys the conditioned air into a vehicle cabin.

### Related Art

For example, in a vehicle seat air conditioner disclosed in Japanese Patent Application Laid-Open (JP-A) No. H11-78484, an air distribution duct provided to a front seat is linked with a rear foot duct. When conditioned air flowing through the rear foot duct flows toward the air distribution duct, conditioned air moves from the front seat toward an occupant in the front seat. This vehicle seat air conditioner also includes a rear vent duct, and conditioned air flowing through the rear vent duct moves toward a rear seat.

However, in this vehicle seat air conditioner, conditioned air is distributed so as to flow through both the rear foot duct and the rear vent duct. Thus, the amount of conditioned air that passes through the rear vent duct and moves toward the rear seat is reduced. Therefore it is difficult for the conditioned air to effectively impart a feeling of warmth (or a feeling of coolness) to an occupant in the rear seat.

### SUMMARY

The present disclosure provides a vehicle air conditioner that may effectively impart a feeling of warmth (or a feeling of coolness) of the conditioned air to a rear seat occupant in a rear seat.

A first aspect of the present disclosure is a vehicle air conditioner including: an air conditioner unit installed in a vehicle, the air conditioner unit generating conditioned air; a first duct having one end connected to the air conditioner unit and another end open at a vehicle front side of a rear seat of the vehicle, the first duct carrying the conditioned air from the air conditioner unit toward a vehicle upper side portion of the rear seat; a second duct, having one end side directly or indirectly connected to the air conditioner unit and another end side laid out inside a front seat of the vehicle, and through which the conditioned air from the air conditioner unit flows; a blower provided at the front seat, the blower blowing out the conditioned air from the other end of the second duct from the front seat; a switch device provided at the one end sides of both the first duct and the second duct, the switch device switching between a first state that permits the conditioned air to flow into the second duct and restricts the conditioned air from flowing into the first duct, and a second state that permits the conditioned air to flow into the first duct and restricts the conditioned air from flowing into the second duct; an occupant detection device detecting whether or not a rear seat occupant is seated at the rear seat; and a controller, based on a detection result of the occupant detection device, controlling the switch device to the first state in a case in which there is no rear seat occupant seated at the rear seat, and to the second state in a case in which an occupant is seated at the rear seat.

In the vehicle air conditioner of the first aspect, the occupant detection device detects whether or not a rear seat occupant is seated in the rear seat. In cases in which the detection result of the occupant detection device indicates that there is no rear seat occupant seated in the rear seat, the switch device is set to the first state by the controller. In the first state, conditioned air generated by the air conditioner unit is restricted from flowing into the first duct, and so conditioned air is restricted from moving from the other end of the first duct toward the vehicle upper side portion of the rear seat. In the first state, conditioned air is permitted to flow into the second duct, and conditioned air that has flowed through the second duct is blown out from the front seat through the blower provided to the front seat.

In cases in which in which a rear seat occupant is seated in the rear seat, the switch device is set to the second state by the controller. In the second state, conditioned air generated by the air conditioner unit is restricted from flowing into the second duct. In the second state, conditioned air is permitted to flow into the first duct, and the conditioned air moves from the other end of the first duct toward the vehicle upper side portion of the rear seat.

Thus, the vehicle air conditioner of the first aspect enables conditioned air to be suppressed from moving toward the rear seat side in a state in which there is no rear seat occupant seated in the rear seat, and enables conditioned air to move toward the rear side and a feeling of warmth (or a feeling of coolness) of the conditioned air to be effectively imparted by the rear seat occupant, in a state in which a rear seat occupant is seated in the rear seat.

If the controller determines that a rear seat occupant is seated in the rear seat, the switch device is set to the second state by the controller. In the second state, conditioned air generated by the air conditioner unit is restricted from flowing into the second duct. In the second state, conditioned air is permitted to flow into the first duct, and the conditioned air moves from the other end of the first duct toward the vehicle upper side portion of the rear seat.

Thus, the vehicle air conditioner of the first aspect may enable conditioned air to be suppressed from moving toward the rear seat side in a state in which there is no rear seat occupant seated in the rear seat, and may enable conditioned air to be moved toward the rear seat side. Accordingly, the first aspect of the present disclosure may effectively impart a rear seat occupant a feeling of warmth (or a feeling of coolness) of the conditioned air, when the rear seat occupant is seated in the rear seat.

A second aspect of the present disclosure, in the above-described first aspect, may further include: a third duct having one end connected to the air conditioner unit and another end open at the vehicle front side of the rear seat of the vehicle further toward a vehicle lower side than the first duct, the third duct carrying the conditioned air from the air conditioner unit toward a vehicle lower side portion of the rear seat, wherein the one end of the second duct may be connected partway between the one end and the other end of the third duct.

In the vehicle air conditioner of the second aspect, the one end of the third duct is connected to the air conditioner unit, and conditioned air generated by the air conditioner unit is able to flow through the third duct. The other end of the third duct is open at the vehicle front side of the rear seat of the vehicle further toward the vehicle lower side than the first duct. Thus, conditioned air that has flowed to the other end of the third duct moves out from the third duct at the vehicle front side of the rear seat of the vehicle and further toward the vehicle lower side than the first duct.

Note that the one end of the second duct is connected partway between the one end and the other end of the third duct, and conditioned air flowing through the third duct is capable of flowing into the second duct from partway along the third duct. Thus, in the vehicle air conditioner of the second aspect, a portion from the one end of the third duct to partway along the third duct serves as both a flow path for conditioned air flowing toward the other end of the third duct, and a flow path for conditioned air flowing through the second duct toward the blower. Accordingly, the second aspect of the present disclosure may obviate the need for the one end of the second duct to be directly connected to the air conditioner unit, and may suppress an increase in the amount of space required to route the second duct in the vehicle.

A third aspect of the present disclosure, in the above-described second aspect, may further include: an air mover provided at the second duct, the air mover drawing in the conditioned air through the one end side of the second duct and conveys the conditioned air toward the other end side of the second duct, wherein the controller may actuate the air mover in the first state.

In the vehicle air conditioner of the third aspect, the air mover is provided to the second duct. The air mover is controlled by the controller, and the air mover is actuated by the controller in the first state, in which the conditioned air is permitted to flow into the second duct and the conditioned air is restricted from flowing into the first duct.

When the air mover is actuated, conditioned air is drawn in through the one end side of the second duct and conveyed toward the other end side of the second duct by the air mover. Accordingly, the third aspect of the present disclosure may effectively blow out the conditioned air through the blower provided to the front seat in the first state.

A fourth aspect of the present disclosure, in the above-described aspects, may further include: a suction device provided inside the front seat, the suction device drawing air at a front seat occupant side of the front seat into the front seat in an actuated state.

In the vehicle air conditioner of the fourth aspect, the suction device is provided inside the front seat, and in the actuated state of the suction device, air on the front seat occupant side of the front seat is drawn into the front seat by the suction device. Thus, in the actuated state of the suction device, an airflow is generated close to the body of the front seat occupant seated in the front seat. Accordingly, the fourth aspect of the present disclosure may enable a feeling of warmth (or a feeling of coolness) to be effectively imparted by the front seat occupant.

A fifth aspect of the present disclosure, in the above-described aspects, may further include: a temperature detection device detecting a temperature inside a vehicle cabin, wherein the controller, based on a detection result of the temperature detection device, may stop the suction device in a case in which the temperature inside the vehicle cabin is below a predetermined value.

In the vehicle air conditioner of the fifth aspect, the temperature inside the vehicle cabin is detected by the temperature detection device. When the temperature detection device detects that the temperature inside the vehicle cabin is below the predetermined value, the controller stops the suction device provided to the front seat. Therefore, in the fifth aspect, the occurrence of an airflow close to the body of the front seat occupant is stopped or suppressed. Accordingly, the fourth aspect of the present disclosure may enable an excessive feeling of warmth (or feeling of coolness) to be suppressed from being imparted by the front seat occupant.

### BRIEF DESCRIPTION OF THE DRAWINGS

Exemplary embodiments will be described in detail based on the following figures, wherein:

FIG. 1 is a side view schematically illustrating a vehicle air conditioner according to an exemplary embodiment of the present disclosure, as viewed from the vehicle width direction left side;

FIG. 2 is a perspective view of a front seat;

FIG. 3 is a cross-section of a seatback of a front seat sectioned along line 3-3 in FIG. 2;

FIG. 4 is a block diagram schematically illustrating a control system of a vehicle air conditioner according to an exemplary embodiment of the present disclosure; and

FIG. 5 is a flowchart schematically illustrating a control system of a vehicle air conditioner according to an exemplary embodiment of the present disclosure.

### DETAILED DESCRIPTION

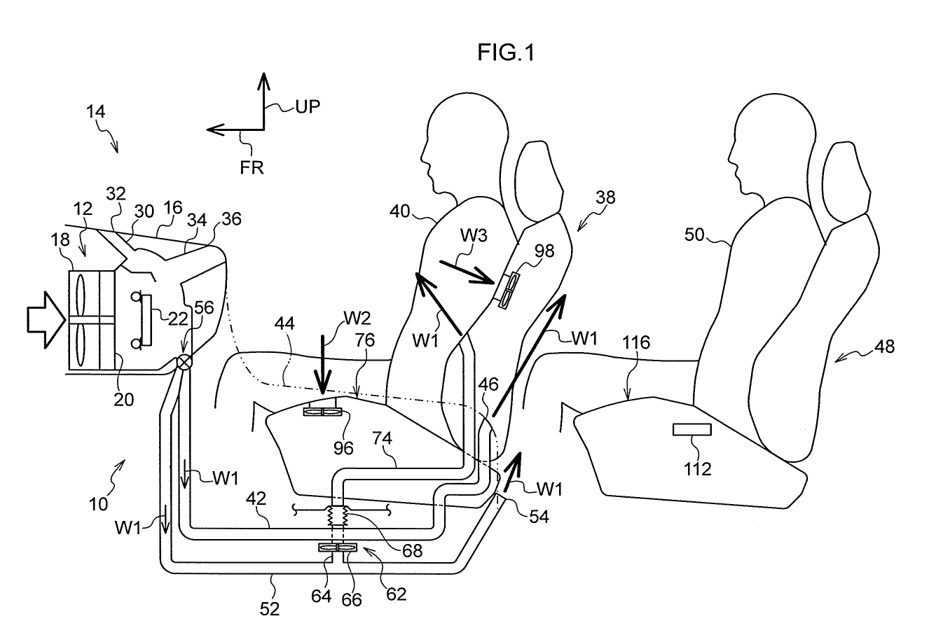

Explanation follows regarding an exemplary embodiment of the present disclosure, based on FIG. 1 to FIG. 5. Note that in each of the drawings, the arrow FR indicates the front side (vehicle front-rear direction front side) of a vehicle 14 applied with a vehicle air conditioner 10 according to an exemplary embodiment of the present disclosure, the arrow UP indicates the vehicle upper side (vehicle vertical direction upper side) and the arrow LH indicates the vehicle width direction left side (vehicle left-right direction left side).

As illustrated in FIG. 1, the vehicle air conditioner 10 according to the present exemplary embodiment includes a Heating, Ventilation, and Air Conditioning (HVAC) unit 12, serving as an air conditioner unit. The HVAC unit 12 is disposed at a vehicle lower front side of an instrument panel 16 of the vehicle 14. The HVAC unit 12 includes a main fan 18. Actuation of the main fan 18 forms an airflow W1. An evaporator 20, a heater core 22, and so on are provided downstream (on the vehicle rear side in FIG. 1) of the main fan 18 along the airflow W1 in order to regulate the temperature, humidity, and so on of the airflow W1 to create conditioned air.

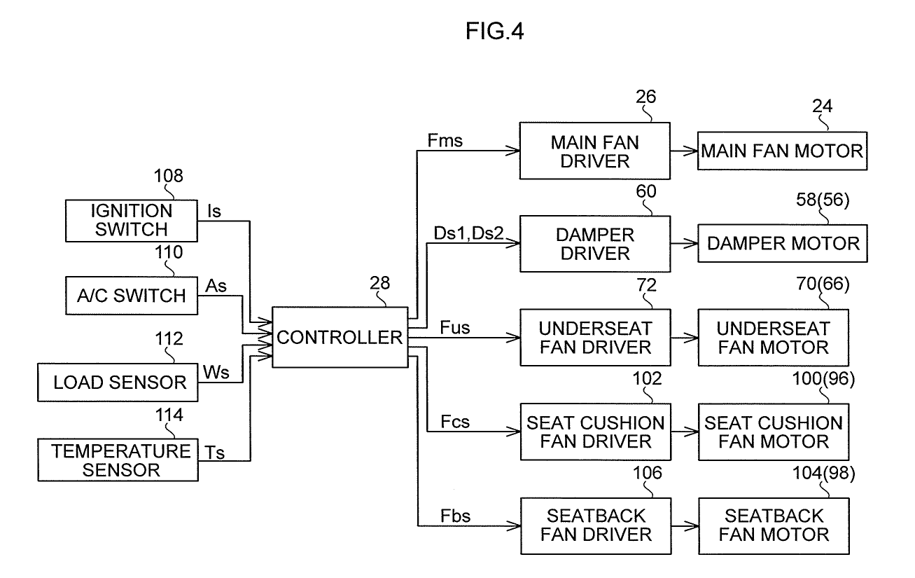

As illustrated in FIG. 4, the main fan 18 includes a main fan motor 24. The main fan 18 is actuated by driving the main fan motor 24. As illustrated in FIG. 4, the main fan motor 24 is electrically connected through a main fan driver 26 to both a controller 28 and a battery (not illustrated in the drawings) mounted to the vehicle 14. The main fan motor 24 is driven by the main fan driver 26 when a high level main fan control signal Fms output from the controller 28 is input to the main fan driver 26.

As illustrated in FIG. 1, one end of a defroster duct 30 is connected to the HVAC unit 12. Another end of the defroster duct 30 is connected to a defroster blower 32. The defroster blower 32 is provided at a vehicle front side end portion of a vehicle upper side section of the instrument panel 16. The airflow W1 that has flowed from the HVAC unit 12 to the defroster duct 30 is conveyed through the defroster blower 32 and blown against a vehicle cabin inner surface of a front windshield (not illustrated in the drawings), thereby removing condensation or the like from the front windshield.

One end of a front face duct 34 is connected to the HVAC unit 12. Another end of the front face duct 34 is connected to a front face blower 36. The front face blower 36 is provided at a vehicle rear side portion of the instrument panel 16. The airflow W1 that has flowed from the HVAC unit 12 to the front face duct 34 is blown out through the front face blower 36 toward the vehicle rear side, and flows toward the upper body of a front seat occupant 40 seated in a front seat 38 of the vehicle 14 (close to the face of the front seat occupant 40, for example).

One end of a rear face duct 42, serving as a first duct, is also connected to the HVAC unit 12. Another end side of the rear face duct 42 is disposed at the vehicle lower side of a center console 44. The center console 44 is provided between a front seat on the vehicle left side (not illustrated in the drawings) and the front seat 38 on the vehicle right side. The other end side of the rear face duct 42 extends toward the vehicle rear side at the vehicle lower side of the center console 44.

The other end of the rear face duct 42 is connected to a rear face blower 46. The rear face blower 46 is disposed at a vehicle upper side portion of a vehicle rear side end section of the center console 44. The airflow W1 that has flowed from the HVAC unit 12 to the rear face duct 42 is blown out through the rear face blower 46 toward the vehicle rear side, and flows toward the upper body of a rear seat occupant 50 seated in a rear seat 48 of the vehicle 14 (close to the face of the rear seat occupant 50, for example).

One end of a rear foot duct 52, serving as a third duct, is connected to the HVAC unit 12. Another end of the rear foot duct 52 is connected to a rear foot blower 54. The rear foot blower 54 is provided at the vehicle lower side of a vehicle rear side end portion of the front seat 38, for example. The airflow W1 that has flowed from the HVAC unit 12 to the rear foot duct 52 is blown out through the rear foot blower 54 toward the vehicle rear side and flows toward the feet of the rear seat occupant 50 seated in the rear seat 48 of the vehicle 14.

A switch module 56, serving as a switch device, is provided at the one end sides of both the rear face duct 42 and the rear foot duct 52. The switch module 56 includes a damper, for example. The damper is mechanically connected to a damper motor 58 through a speed reduction mechanism as illustrated in FIG. 4, for example, and is moved to-and-fro by drive force of the damper motor 58.

When the damper is moved toward one side of its to-and-fro movement range, the switch module 56 is placed in a first state. In the first state, all or most of the one end of the rear face duct 42 is closed off by the damper, and the one end of the rear foot duct 52 is open. Thus, all or most of the airflow W1 generated by the HVAC unit 12 that has flowed into the vicinity of the one end of the rear foot duct 52 and the one end of the rear face duct 42 flows into the rear foot duct 52.

In contrast thereto, when the damper is moved toward the other side of its to-and-fro movement range, the switch module 56 is placed in a second state. In the second state, all or most of the one end of the rear foot duct 52 is closed off by the damper, and the one end of the rear face duct 42 is open. Thus, all or most of the airflow W1 generated by the HVAC unit 12 that has flowed into the vicinity of the one end of the rear face duct 42 and the one end of the rear foot duct 52 flows into the rear face duct 42.

As illustrated in FIG. 4, the damper motor 58 of the switch module 56 is connected through a damper driver 60 to both the controller 28 and the battery (not illustrated in the drawings) mounted at the vehicle 14. When a first damper drive signal Ds1 output from the controller 28 is input to the damper driver 60, the damper motor 58 is driven by the damper driver 60 so as to move the damper toward the one side of its to-and-fro movement range. When a second damper drive signal Ds2 output from the controller 28 is input to the damper driver 60, the damper motor 58 is driven by the damper driver 60 so as to move the damper toward the other side of its to-and-fro movement range.

One end of a front foot duct (not illustrated in the drawings) is also connected to the HVAC unit 12. Another end of the front foot duct is connected to a front foot blower (not illustrated in the drawings). For example, the rear foot blower 54 is provided at the vehicle lower side of the vehicle rear side end portion of the front seat 38, and the front foot blower is provided at a vehicle lower side portion of a vehicle rear side section of the instrument panel 16. The airflow W1 that has flowed from the HVAC unit 12 to the front foot duct is blown out through the front foot blower toward the vehicle lower side, and flows toward the feet of the front seat occupant 40 seated in the front seat 38 of the vehicle 14.

As illustrated in FIG. 1, the vehicle air conditioner 10 includes a seat ventilation system 62 (hereafter referred to as an SVS 62). The SVS 62 includes a branch duct 64, configuring a second duct. One end of the branch duct 64 is connected to the rear foot duct 52 substantially at the vehicle lower side of the front seat 38. Another end of the branch duct 64 is connected to an underseat fan 66, serving as an air mover.

One end of a seat-side duct 68, configuring the second duct together with the branch duct 64, is connected to the underseat fan 66. When the underseat fan 66 is actuated, air is drawn into the underseat fan 66 from the branch duct 64 side. Thus, when the underseat fan 66 is actuated, at least some of the airflow W1 flowing through the rear foot duct 52 flows into the branch duct 64, preventing or suppressing the airflow W1 from flowing toward the rear foot blower 54. The underseat fan 66 is connected to the one end of the seat-side duct 68, and so air conveyed through the underseat fan 66 flows through the seat-side duct 68.

The underseat fan 66 includes an underseat fan motor 70 as illustrated in FIG. 4. The underseat fan 66 is actuated by driving the underseat fan motor 70. As illustrated in FIG. 4, the underseat fan motor 70 is electrically connected through an underseat fan driver 72 to both the controller 28 and the battery (not illustrated in the drawings) mounted on the vehicle 14. When a high level underseat fan control signal Fus output from the controller 28 is input to the underseat fan driver 72, the underseat fan motor 70 is driven by the underseat fan driver 72.

As illustrated in FIG. 1, another end of the seat-side duct 68 is connected to one end of an in-seat duct 74, configuring the second duct together with the branch duct 64 and the seat-side duct 68. The in-seat duct 74 is provided inside a seat cushion 76 and a seatback 78 of the front seat 38. The one end of the in-seat duct 74 is open at a vehicle lower side end of the seat cushion 76. Note that the seat-side duct 68 is formed in a concertina shape, for example. The seat-side duct 68 is capable of deforming such that another end side portion of the seat-side duct 68 moves in the vehicle front-rear direction and vehicle vertical direction with respect to one end side portion of the seat-side duct 68. The other end of the seat-side duct 68 is thereby capable of following vehicle front-rear direction and vehicle vertical direction movement of the front seat 38, while the position of the one end of the seat-side duct 68 does not change.

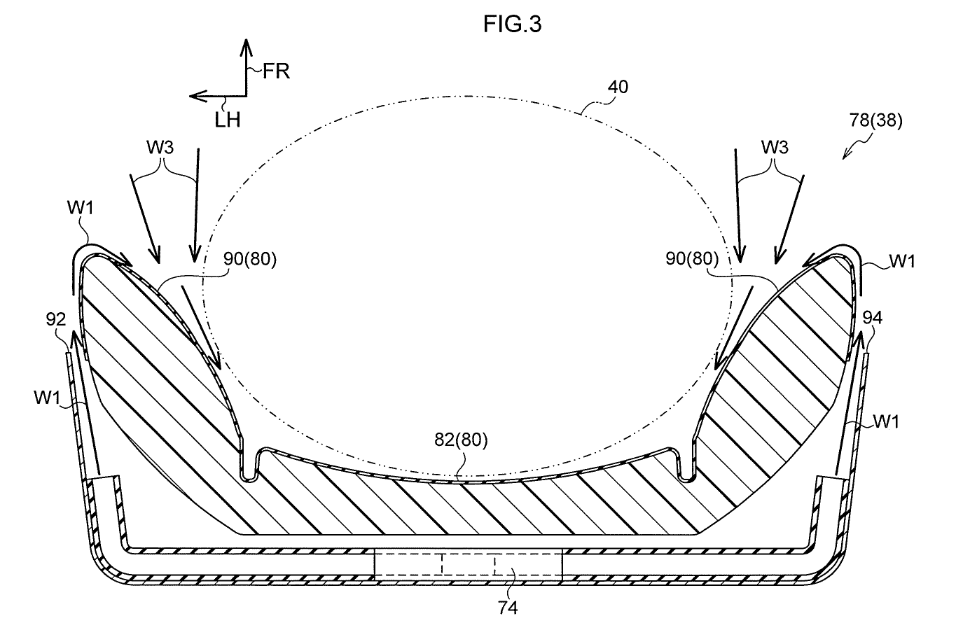

As illustrated in FIG. 3, another end side of the in-seat duct 74 branches into two, and is disposed between a pad central portion 82 of a seat pad 80 configuring the seatback 78 of the front seat 38, and a back plate 86 of a back board 84.

Another end portion of one branch of the in-seat duct 74 is disposed between a pad side portion 90 at the vehicle left side (seat left side) of the seat pad 80 and a side plate 88 at the vehicle left side (seat left side) of the back board 84, and is capable of conveying the airflow W1 that has passed through the in-seat duct 74 toward the vehicle front side (seat front side). A left side blower 92, serving as a blower, is configured by a vehicle front side end (seat front side end) of the side plate 88 at the vehicle left side (seat left side) of the back board 84 and the pad side portion 90 at the vehicle left side (seat left side) of the seat pad 80.

The airflow W1 that has been conveyed through the other end portion of the one branch of the in-seat duct 74 and out of the in-seat duct 74 passes between the pad side portion 90 on the vehicle left side (seat left side) of the seat pad 80 and the side plate 88 on the vehicle left side (seat left side) of the back board 84, and is blown out through the left side blower 92 to the exterior of the seatback 78. The airflow W1 that has been blown out of the left side blower 92 in this manner flows along a vehicle width direction left side face (seat width direction left side face) of the pad side portion 90 toward the vehicle front side (seat front side).

Another end portion of the other branch of the in-seat duct 74 is disposed between a pad side portion 90 on the vehicle right side (seat right side) of the seat pad 80 and a side plate 88 on the vehicle right side (seat right side) of the back board 84, and is capable of conveying the airflow W1 that has passed through the in-seat duct 74 toward the vehicle front side (seat front side). A right side blower 94, serving as a blower, is configured by a vehicle front side end (side front seat end) of the side plate 88 at the vehicle right side (seat right side) of the back board 84 and the pad side portion 90 at the vehicle right side (seat right side) of the seat pad 80.

The airflow W1 that has been conveyed through the other end portion of the other branch of the in-seat duct 74 and out of the in-seat duct 74 passes between the pad side portion 90 at the vehicle right side (seat right side) of the seat pad 80 and the side plate 88 at the vehicle right side (seat right side) of the back board 84, and is blown out through the right side blower 94 toward the exterior of the seatback 78. The airflow W1 that has been blown out through the right side blower 94 in this manner flows along a vehicle width direction right side face (seat width direction right side face) of the pad side portion 90 toward the vehicle front side (seat front side).

As illustrated in FIG. 1 and FIG. 3, the SVS 62 includes a seat cushion fan 96, serving as a suction device, and a seatback fan 98, also serving as a suction device. The seat cushion fan 96 is provided inside the seat cushion 76 of the front seat 38. When the seat cushion fan 96 is actuated, air is drawn into the seat cushion 76 from the vehicle upper side (seat upper side) of the seat cushion 76. Thus, for example, when the seat cushion fan 96 is actuated in a state in which the front seat occupant 40 is seated at the front seat 38, an airflow W2 (see FIG. 1) is generated so as to pass alongside the thighs and buttocks of the front seat occupant 40 from the vehicle upper front side (seat upper front side), vehicle upper left side (seat upper left side), vehicle upper right side (seat upper right side), and so on of the seat cushion 76.

The seat cushion fan 96 includes a seat cushion fan motor 100 as illustrated in FIG. 4. The seat cushion fan 96 is actuated by driving the seat cushion fan motor 100. As illustrated in FIG. 4, the seat cushion fan motor 100 is electrically connected through a seat cushion fan driver 102 to both the controller 28 and the battery (not illustrated in the drawings) mounted to the vehicle 14. When a high level seat cushion fan control signal Fcs output from the controller 28 is input to the seat cushion fan driver 102, the seat cushion fan motor 100 is driven by the seat cushion fan driver 102.

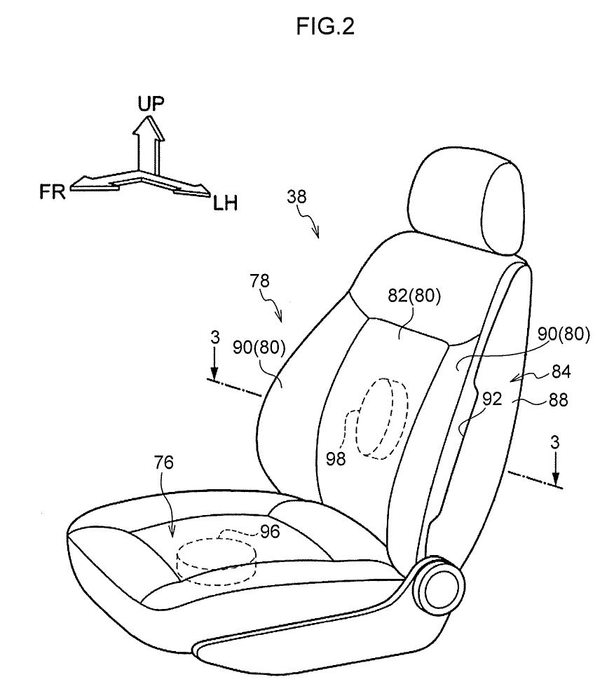

As illustrated in FIG. 1 and FIG. 2, the seatback fan 98 is provided inside the seatback 78 of the front seat 38. When the seatback fan 98 is actuated, air is drawn inside the seatback 78 from the vehicle front side (seat front side) of the seatback 78. Thus, for example, when the seatback fan 98 is actuated in a state in which the front seat occupant 40 is seated at the front seat 38, an airflow W3 (see FIG. 1 and FIG. 3) is generated so as to pass both vehicle width direction sides of the body of the front seat occupant 40 from the vehicle left side (seat left side), vehicle right side (seat right side), and so on of the seatback 78.

The seatback fan 98 includes a seatback fan motor 104 as illustrated in FIG. 4. The seatback fan 98 is actuated by driving the seatback fan motor 104. As illustrated in FIG. 4, the seatback fan motor 104 is electrically connected through a seatback fan driver 106 to both the controller 28 and the battery (not illustrated in the drawings) mounted on the vehicle 14. When a high level seatback fan control signal Fbs output from the controller 28 is input to the seatback fan driver 106, the seatback fan motor 104 is driven by the seatback fan driver 106.

As illustrated in FIG. 4, the controller 28 is electrically connected to various switches, including an ignition switch 108 and an A/C switch 110, and to various sensors, including a load sensor 112 and a temperature sensor 114. The ignition switch 108 is provided in the vicinity of the front seat 38, this being the driving seat of the vehicle 14. When the ignition switch 108 is operated, the engine of the vehicle 14 starts up and an ignition signal Is output from the ignition switch 108 switches from low level to high level.

The A/C switch 110 is provided to the instrument panel 16 of the vehicle 14. When the A/C switch 110 is operated, an A/C signal As output from the A/C switch 110 switches from low level to high level, and the main fan control signal Fms output from the controller 28 switches from low level to high level.

The load sensor 112 is provided, for example, in a seat cushion 116 of the rear seat 48 as illustrated in FIG. 1. When a load applied to the seat cushion 116 of the rear seat 48 from the vehicle upper side exceeds a predetermined magnitude, a load detection signal Ws output from the load sensor 112 switches from low level to high level.

The temperature sensor 114 detects the temperature inside the cabin of the vehicle 14. When the temperature inside the cabin of the vehicle 14 is below a predetermined value, a temperature detection signal Ts output from the temperature sensor 114 switches from high level to low level.

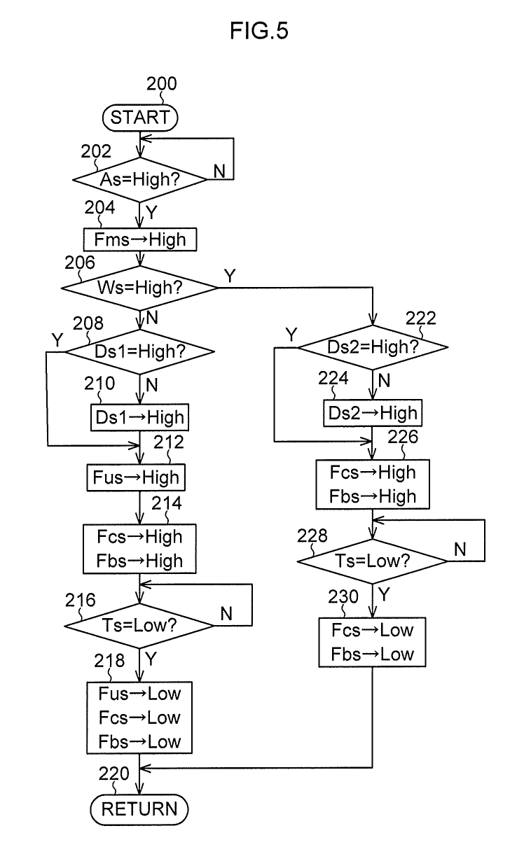

Explanation follows regarding operation when the vehicle air conditioner 10 is performing a cooling operation, based on the flowchart in FIG. 5.

For example, the controller 28 starts control of the vehicle air conditioner 10 (step 200) when the ignition switch 108 has been operated such that the engine of the vehicle 14 starts up and the ignition signal Is output from the ignition switch 108 and input to the controller 28 switches from low level to high level. Next, at step 202, determination is made as to whether or not the A/C switch 110 has been operated such that the A/C signal As output from the A/C switch 110 has switched from low level to high level.

When the A/C switch 110 has been operated such that the A/C signal As is high level and the vehicle air conditioner 10 starts up, at step 204, the main fan control signal Fms output from the controller 28 switches from low level to high level. The main fan motor 24 is driven and the main fan 18 is accordingly actuated.

Next, at step 206, determination is made as to whether or not the load detection signal Ws output from the load sensor 112 is high level. In cases in which there is no rear seat occupant 50 seated at the rear seat 48, the load detection signal Ws output from the load sensor 112 is low level, and so at steps 208, 210 a high level first damper drive signal Dsl is output from the controller 28. The switch module 56 is accordingly set to the first state, in which all or most of the one end of the rear face duct 42 is closed off by the damper of the switch module 56 and the one end of the rear foot duct 52 is open. Thus, all or most of the airflow (cool air) W1 of conditioned air generated by the HVAC unit 12 that has flowed into the vicinity of the one end of the rear foot duct 52 and the one end of the rear face duct 42 flows into the rear foot duct 52.

At step 212, a high level underseat fan control signal Fus is output from the controller 28. When the underseat fan motor 70 is driven to actuate the underseat fan 66 in response, at least some of the airflow W1 flowing through the rear foot duct 52 thereby flows into the branch duct 64, and the airflow W1 is prevented or suppressed from flowing toward the rear foot blower 54. From the underseat fan 66, the airflow W1 that has flowed into the branch duct 64 is conveyed through the seat-side duct 68 and into the in-seat duct 74.

The airflow W1 that has flowed through the in-seat duct 74 is conveyed out of the in-seat duct 74 through the other end of the in-seat duct 74 at the vehicle left side (seat left side) and through the other end of the in-seat duct 74 at the vehicle right side (seat right side), and is blown out through the left side blower 92 and the right side blower 94.

Next, at step 214, a high level seat cushion fan control signal Fcs and a high level seatback fan control signal Fbs are output from the controller 28. Thus, the seat cushion fan motor 100 of the seat cushion fan 96 provided in the seat cushion 76 of the front seat 38 is driven to actuate the seat cushion fan 96, and the seatback fan motor 104 of the seatback fan 98 provided in the seatback 78 of the front seat 38 is driven to actuate the seatback fan 98.

When the seat cushion fan 96 has been actuated, the airflow W2 is generated so as to pass alongside the thighs and buttocks of the front seat occupant 40 from the vehicle upper front side (seat upper front side), vehicle upper left side (seat upper left side), vehicle upper right side (seat upper right side), and so on of the seat cushion 76 and flow into the seat cushion 76. When the seatback fan 98 has been actuated, the airflow W3 is generated so as to pass both vehicle width direction sides of the body of the front seat occupant 40 from the vehicle upper front side (seat upper front side), vehicle upper left side (seat upper left side), vehicle upper right side (seat upper right side), and so on of the seatback 78 and flow into the seatback 78.

When the airflow W1 is blown out from both the left side blower 92 and the right side blower 94 of the front seat 38 in this state, at least some of the airflow WI converges with the airflows W2, W3. The airflow W1 that has converged with the airflows W2, W3 passes alongside the thighs and buttocks of the front seat occupant 40 and both vehicle width direction sides of the body of the front seat occupant 40 together with the airflows W2, W3. Note that the airflow W1 is configured by cool air (conditioned air) generated by the HVAC unit 12. This enables a feeling of coolness to be effectively imparted by the front seat occupant 40.

Next, at step 216, determination is made as whether or not the temperature detection signal Ts output from the temperature sensor 114 has switched from high level to low level. When the temperature inside the cabin of the vehicle 14 falls below the predetermined value and the temperature detection signal Ts output from the temperature sensor 114 switches from high level to low level, at step 218, the underseat fan control signal Fus, the seat cushion fan control signal Fcs, and the seatback fan control signal Fbs output from the controller 28 are all switched from high level to low level.

The underseat fan 66, the seat cushion fan 96, and the seatback fan 98 are all stopped accordingly. Thus, the airflow W2 passing alongside the thighs and buttocks of the front seat occupant 40 and flowing into the seat cushion 76, and the airflow W3 passing both vehicle width direction sides of the body of the front seat occupant 40 and flowing into the seatback 78 are stopped, and the airflow W1 blowing out through both the left side blower 92 and the right side blower 94 of the front seat 38 is suppressed. This may suppress an excessive feeling of coolness from being imparted by the front seat occupant 40.

In this manner, the present exemplary embodiment may enable a feeling of coolness to be effectively imparted by the front seat occupant 40 seated in the front seat 38 in a state in which there is no rear seat occupant 50 seated in the rear seat 48.

In cases in which a rear seat occupant 50 is seated in the rear seat 48 and the load detection signal Ws output from the load sensor 112 is accordingly determined to be high level at step 206, at steps 222, 224, the second damper drive signal Ds2 output from the controller 28 is set to high level. The switch module 56 is thereby set to the second state, such that all or most of the one end of the rear foot duct 52 is closed off by the damper of the switch module 56 and the one end of the rear face duct 42 is open. Thus, all or most of the airflow (cool air) W1 generated by the HVAC unit 12 that has flowed into the vicinity of the one end of the rear face duct 42 and the one end of the rear foot duct 52 flows into the rear face duct 42.

Accordingly, the airflow W1 that flows through the rear face duct 42 is blown out through the rear face blower 46 disposed at the vehicle upper side portion of the vehicle rear side end section of the center console 44 and toward the upper body of the rear seat occupant 50 seated in the rear seat 48 (close to the face of the rear seat occupant 50, for example). Note that the airflow W1 is cool air generated by the HVAC unit 12. Blowing the airflow W1 out toward the upper body of the rear seat occupant 50 in this manner may enable a feeling of coolness to be effectively imparted by the rear seat occupant 50.

Next, at step 226, a high level seat cushion fan control signal Fcs and a high level seatback fan control signal Fbs are output from the controller 28. This actuates the seat cushion fan 96 and the seatback fan 98 provided to the front seat 38, thereby generating the airflow W2 passing alongside the thighs and buttocks of the front seat occupant 40 and flowing into the seat cushion 76, and the airflow W3 passing both vehicle width direction sides of the body of the front seat occupant 40 and flowing into the seatback 78.

Note that, in this state, the airflow W1 of cool air is not blown out through the left side blower 92 and the right side blower 94 of the front seat 38. However, in this state, the airflow W1 of cool air is blown out from the rear face blower 46 into the cabin of the vehicle 14. In addition, in this state the airflow W1 that flows into the front face duct 34 is blown out through the front face blower 36 toward the upper body of the front seat occupant 40 (close to the face of the front seat occupant 40, for example). When cool air that has been blown out through the rear face blower 46 and the front face blower 36 in this manner and that has traveled around the cabin of the vehicle 14 by convection converges with the airflows W2, W3, the cool air passes alongside the thighs and buttocks of the front seat occupant 40 and both vehicle width direction sides of the body of the front seat occupant 40. This may enable a feeling of coolness to be imparted by the front seat occupant 40.

Next, at step 228, determination is made as to whether or not the temperature detection signal Ts output from the temperature sensor 114 has switched from high level to low level. When the temperature inside the cabin of the vehicle 14 falls below the predetermined value and the temperature detection signal Ts output from the temperature sensor 114 switches from high level to low level, at step 230, the seat cushion fan control signal Fcs and the seatback fan control signal Fbs output from the controller 28 are both switched from high level to low level.

The seat cushion fan 96 and the seatback fan 98 are both stopped in response. Thus, the airflow W2 passing alongside the thighs and buttocks of the front seat occupant 40 and flowing into the seat cushion 76, and the airflow W3 passing both vehicle width direction sides of the body of the front seat occupant 40 and flowing into the seatback 78 are stopped. Accordingly, the present exemplary embodiment may suppress an excessive feeling of coolness from being imparted by the front seat occupant 40.

Thus, in a state in which the rear seat occupant 50 is seated in the rear seat 48, the present exemplary embodiment may enable a feeling of coolness to be effectively imparted by the rear seat occupant 50, and may suppress a reduction in the feeling of coolness imparted by the front seat occupant 40 seated in the front seat 38.

In cases in which the vehicle air conditioner 10 is performing a heating operation, for example, warm air generated by the HVAC unit 12 passes through the front foot duct and is blown out through the front foot blower toward the feet of the front seat occupant 40 seated in the front seat 38, and also passes through the rear foot duct 52 and is blown out through the rear foot blower 54 toward the feet of the rear seat occupant 50 seated in the rear seat 48.

Namely, both a flow path for cool air that flows toward the branch duct 64 side and a flow path for warm air that flows toward the rear foot blower 54 are configured between the one end of the rear foot duct 52 and the branch duct 64. Since the rear foot duct 52 is commonly employed as both the flow path for cool air flowing toward the branch duct 64 side and the flow path for warm air flowing toward the rear foot blower 54, there is no need to provide a separate duct that directly links the underseat fan 66 and the HVAC unit 12 together in addition to the rear foot duct 52. This may suppress an increase in the number of components, and may eliminate the need to provide a space through which to route a separate duct that directly links the underseat fan 66 and the HVAC unit 12 together in addition to the rear foot duct 52.

Furthermore, the vehicle air conditioner 10 includes the underseat fan 66. Thus, even in a configuration in which the rear foot duct 52 is commonly employed as both the flow path for cool air flowing toward the branch duct 64 side and the flow path for warm air flowing toward the rear foot blower 54, actuating the underseat fan 66 enables the airflow W1 to be prevented or suppressed from flowing toward the rear foot blower 54 and enables the airflow W1 to be made to flow toward branch duct 64 side.

When the underseat fan 66 is in an inactive state, the fan blades configuring the underseat fan 66 provide resistance to the flow of air through the branch duct 64 toward the underseat fan 66. Thus, when the vehicle air conditioner 10 is performing a heating operation, placing the underseat fan 66 in the stationary state enables warm air to be prevented or suppressed from flowing into the branch duct 64, and enables warm air to flow efficiently toward the rear foot blower 54.

Note that, in the present exemplary embodiment, a case in which the one end of the branch duct 64 configuring the second duct is connected partway between the one end and the other end of the rear foot duct 52, serving as the third duct, has been described. However, the one end of the second duct may be directly connected to the HVAC unit 12 serving as the unit.

In the present exemplary embodiment, a case in which the underseat fan 66, serving as an air mover, is provided between the branch duct 64 and the seat-side duct 68 that configure the second duct, has been described. However, the underseat fan 66 serving as an air mover may not be provided.

In the present exemplary embodiment, a case in which a portion connecting the branch duct 64, configuring the second duct, and the rear foot duct 52, serving as the third duct, is not provided with a damper or the like, has been described. However, a flow path switch device such as a damper may be provided at a portion connecting between the branch duct 64 and the rear foot duct 52, such that, for example, the branch duct 64 side is open and the rear foot blower 54 side of the rear foot duct 52 is closed off during a cooling operation, and the branch duct 64 side is closed off and the rear foot blower 54 side of the rear foot duct 52 is open during a heating operation.

In the present exemplary embodiment, a case in which the seat cushion fan 96, serving as a suction device, and the seatback fan 98, also serving as a suction device, are provided to the front seat 38, has been described. However, only one out of the seat cushion fan 96 or the seatback fan 98 may be provided, neither the seat cushion fan 96 nor the seatback fan 98 may be provided.

In the present exemplary embodiment, an occupant detection device is configured by the load sensor 112 provided to the rear seat 48. However, for example, a configuration may be applied in which an occupant detection device is configured by an imaging device provided to the vehicle 14, in which the imaging device images the rear seat 48, and the controller 28 determines whether or not a rear seat occupant 50 is seated in the rear seat 48 based on an imaging result. Thus, there is no limitation to a specific format, as long as the occupant detection device is able to detect whether or not a rear seat occupant 50 is seated in the rear seat 48.

What is claimed is:

1. A vehicle air conditioner comprising:
an air conditioner unit installed in a vehicle, the air conditioner unit generating conditioned air;
a first duct having one end connected to the air conditioner unit and another end open at a vehicle front side of a rear seat of the vehicle, the first duct carrying the conditioned air from the air conditioner unit toward a vehicle upper side portion of the rear seat;
a second duct, having one end side directly or indirectly connected to the air conditioner unit and another end side laid out inside a front seat of the vehicle, and through which the conditioned air from the air conditioner unit flows;
a blower provided at the front seat, the blower blowing out the conditioned air from the other end of the second duct from the front seat;
a switch device provided at the one end sides of both the first duct and the second duct, the switch device switching between a first state that permits the conditioned air to flow into the second duct and restricts the conditioned air from flowing into the first duct, and a second state that permits the conditioned air to flow into the first duct and restricts the conditioned air from flowing into the second duct;
an occupant detection device detecting whether or not a rear seat occupant is seated at the rear seat; and
a controller, based on a detection result of the occupant detection device, controlling the switch device to the first state in a case in which there is no rear seat occupant seated at the rear seat, and to the second state in a case in which an occupant is seated at the rear seat.

2. The vehicle air conditioner of claim 1, further comprising a third duct having one end connected to the air conditioner unit and another end open at the vehicle front side of the rear seat of the vehicle further toward a vehicle lower side than the first duct, the third duct carrying the conditioned air from the air conditioner unit toward a vehicle lower side portion of the rear seat,
wherein the one end of the second duct is connected partway between the one end and the other end of the third duct.

3. The vehicle air conditioner of claim 2, further comprising an air mover provided at the second duct, the air mover drawing in the conditioned air through the one end side of the second duct and conveys the conditioned air toward the other end side of the second duct,
wherein the controller actuates the air mover in the first state.

4. The vehicle air conditioner of claim 1, further comprising a suction device provided inside the front seat, the suction device drawing air at a front seat occupant side of the front seat into the front seat in an actuated state.

5. The vehicle air conditioner of claim 4, further comprising a temperature detection device detecting a temperature inside a vehicle cabin,
wherein the controller, based on a detection result of the temperature detection device, stops the suction device in a case in which the temperature inside the vehicle cabin is below a predetermined value.
